(19) United States
(12) Patent Application Publication
(10) Pub. No.: US 2025/0223935 A1
(43) Pub. Date: Jul. 10, 2025

(54) ADDITIVELY MANUFACTURED SOLID PROPELLANT MATERIAL FOR ROCKET ENGINES

(71) Applicant: Firehawk Aerospace, Inc., Addison, TX (US)

(72) Inventors: Michael Joseph Baier, Garland, TX (US); Justin Otto Karl, Titusville, FL (US); Andrew Copeland, Plano, TX (US); Ben Giles, Euless, TX (US)

(21) Appl. No.: 19/013,686

(22) Filed: Jan. 8, 2025

Related U.S. Application Data
(60) Provisional application No. 63/619,209, filed on Jan. 9, 2024.

(51) Int. Cl. F02K 9/14; B29C 64/118; B29L 31/20; B29L 31/30; B33Y 10/00; B33Y 80/00

(52) U.S. Cl. CPC F02K 9/14; B29C 64/118; B33Y 10/00; B33Y 80/00; B29L 2031/20; B29L 2031/3097

(57) ABSTRACT

A method includes depositing beads of solid propellant material using additive manufacturing to form a fuel element for a rocket engine, the fuel element including beads of solid propellant material, wherein a combustion port extends through the fuel element, wherein the solid propellant material includes an oxidizer and a binder material.

### CLAIM OF PRIORITY

This application claims priority under 35 USC § 119 (e) to U.S. Patent Application Ser. No. 63/619,209, filed on Jan. 9, 2024, the entire contents of which are hereby incorporated by reference.

### BACKGROUND

There are various types of chemical rocket propulsion systems. Liquid rocket engines use liquid-phase propellants. Solid rocket motors use solid-phase propellants. Hybrid rocket engines use a combination of liquid and solid-phase propellant constituents. In a hybrid rocket engine, oxidizer is typically in liquid or vapor state and fuel is in solid or semi-solid state. The fuel is formed into a tubular shaped fuel grain with one or more ports that serve via pyrolization as the fuel source and as the engine's combustion chamber(s).

### SUMMARY

We describe here approaches to additive manufacturing of solid propellant material, such as thermoplastic based solid propellants. Additive manufacturing of solid propellant material can be used to fabricate fuel elements, such as solid propellant grains for solid rocket motors or hybrid rocket engine fuel grain assemblies including both hybrid fuel grain material and solid propellant.

In an aspect, a method includes depositing beads of solid propellant material using additive manufacturing to form a fuel element for a rocket engine, the fuel element including beads of solid propellant material, wherein a combustion port extends through the fuel element, wherein the solid propellant material includes an oxidizer and a binder material.

Embodiments can include one or any combination of two or more of the following features.

The fuel element includes a solid propellant grain for a solid rocket motor.

The fuel element includes a fuel grain assembly for a hybrid rocket engine.

Depositing beads of solid propellant material includes extruding the solid propellant material from a nozzle of an additive manufacturing system.

The method includes depositing beads of solid propellant material to form at least one layer composed of solid propellant material. In some cases, the method includes depositing multiple concentric beads of solid propellant material such that the fuel element includes multiple layers of beads.

The method includes depositing beads of solid propellant material such that innermost beads of the solid propellant material define a wall of the combustion port and outermost beads of the solid propellant material define an outer surface of the fuel element.

The method includes depositing beads of solid propellant material of different compositions such that a composition of the fuel element varies radially, circumferentially, or axially.

The method includes depositing the beads of solid propellant material at a temperature that is lower than an ignition temperature of the solid propellant material.

The solid propellant material includes a solid fuel additive.

The method includes depositing beads of fuel grain material in contact with the beads of solid propellant material to form a fuel grain assembly for a hybrid rocket engine, the fuel grain assembly including one or more layers of fuel grain material, wherein the fuel grain material includes a polymer based rocket fuel material. In some cases, the method includes depositing beads of the solid propellant material and the fuel grain material such that beads of the solid propellant material define a wall of the combustion port and beads of the hybrid fuel grain material define an outer surface of the hybrid fuel grain assembly. In some cases, the method includes depositing beads of the solid propellant material and the fuel grain material such that beads of the solid propellant material and beads of the hybrid fuel grain material together define a wall of the combustion port. In some cases, the method includes depositing beads of the solid propellant material and the fuel grain material such that solid propellant material is disposed between layers of the hybrid fuel grain material. In some cases, the method includes depositing beads of the solid propellant material such that a thickness of the solid propellant material varies along a length of the hybrid fuel grain assembly.

In an aspect, a method includes dissolving a binder material for a solid propellant material in a first solvent to produce a mixture; introducing a solid oxidizer into the mixture; separating the binder material and solid oxidizer from the first solvent to form a precipitate composed of solid propellant material; and processing the precipitate to form filaments or pellets of the solid propellant material, wherein the filaments or pellets are configured for additive manufacturing of the solid propellant material.

Embodiments can include one or any combination of two or more of the following features.

The method includes introducing a solid fuel additive into the mixture and separating the binder mixture, solid oxidizer, and solid fuel additive from the first solvent to form the precipitate.

Separating the binder material and solid oxidizer from the first solvent includes evaporating the first solvent.

Separating the binder material and solid oxidizer from the solvent includes adding a second solvent to the mixture to induce precipitation of the binder material and solid oxidizer from the first solvent. In some cases, the second solvent is miscible with the first solvent, and wherein the binder material and solid oxidizer are insoluble in the second solvent.

Processing the solid precipitate to form pellets includes forming a sheet of the precipitate.

Processing the solid precipitate to form filaments or pellets includes extruding the precipitate through a die to produce an extrudate.

Processing the solid precipitate to form filament or pellets includes extruding the precipitate through a screw extruder.

The method includes combining a second solvent with the precipitate during the processing. In some cases, the binder material and solid oxidizer are insoluble in the second solvent. In some cases, in the presence of the second solvent, an external surface of an extrudate or filament or pellet produced during the processing is solidified.

The method includes providing the filaments or pellets to an additive manufacturing tool for deposition of the solid propellant material.

The details of one or more implementations are set forth in the accompanying drawings and the description below. Other features and advantages will be apparent from the description and drawings, and from the claims.

### BRIEF DESCRIPTION OF DRAWINGS

FIG. 1A is a perspective view of a solid propellant grain.

FIG. 1B is a diagram of a method of manufacturing the solid propellant grain of FIG. 1A.

FIG. 2 is a cross-sectional view of a solid propellant grain.

FIGS. 3A and 3B are perspective and cross-sectional views, respectively, of a hybrid fuel grain assembly.

FIGS. 4A and 4B are cross-sectional diagrams of a method of manufacturing a hybrid fuel grain assembly.

FIGS. 5-7 are cross-sectional diagrams of hybrid fuel grain assemblies.

FIG. 8 is a flow chart.

### DETAILED DESCRIPTION

We describe here approaches to additive manufacturing of solid propellant material, such as thermoplastic based solid propellants. Additive manufacturing of solid propellant material can be used to fabricate solid propellant grains for solid rocket motors or to fabricate hybrid rocket engine fuel grain assemblies including both hybrid fuel grain material and solid propellant.

Generally, in fused deposition additive manufacturing, a material (e.g., hybrid fuel grain material or solid propellant material) is extruded from a deposition head of an additive manufacturing system and deposited as beads, which fuse with adjacent beads and solidify to form a structure composed of a stacked set of layers. Concentric beads of different compositions can be deposited to create solid propellant grains for solid rocket motors or to create a hybrid rocket engine fuel grain assembly with compositional variations, e.g., with regions of hybrid fuel grain material and regions of solid propellant material, or with regions of different formulations of either material.

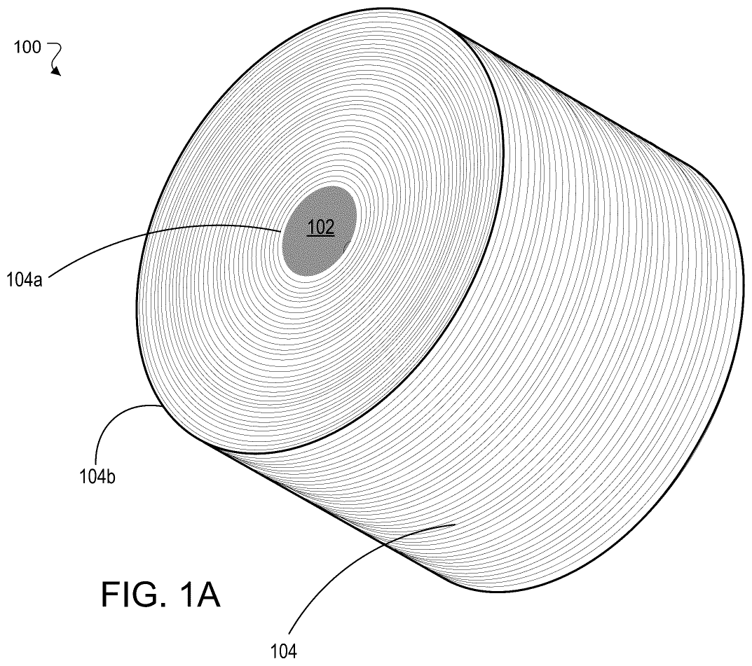

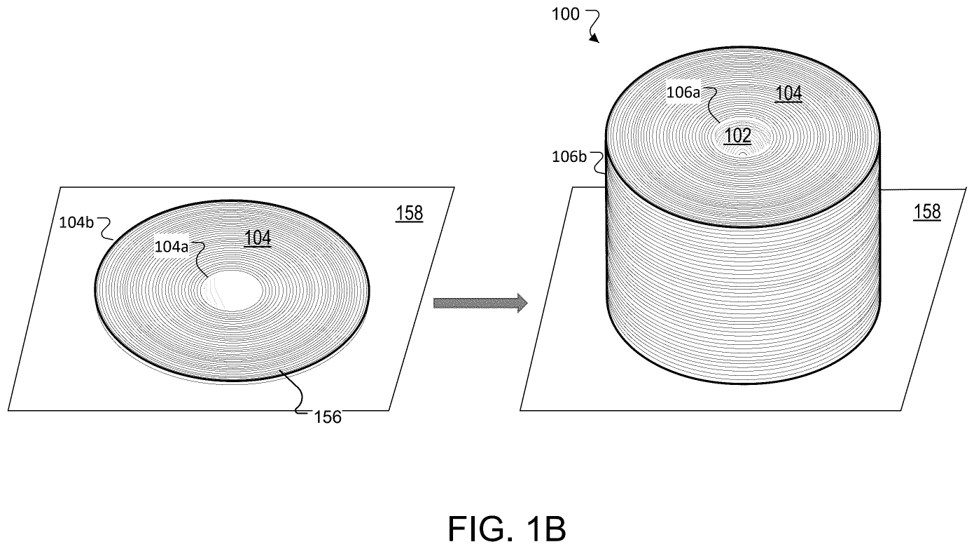

FIG. 1A is a perspective view of a solid propellant grain 100 fabricated by additive manufacturing. The solid propellant grain 100 as illustrated is a generally cylindrical shape with a substantially circular cross section. A hollow combustion port 102 is defined in the interior of the solid propellant grain 100, e.g., centered within the solid propellant grain, and extends axially along the length of the solid propellant grain 100. The combustion port 102 has a substantially circular cross section. Other shapes of the solid propellant grains and/or combustion port can be achieved via differently sized beads. For instance, solid propellant grains can be elongated, non-cylindrical structures, disc-shaped structures, or other suitable shapes. Additionally, solid propellant grains can have various shapes of combustion ports, and can have one or multiple combustion ports. For instance, the combustion ports are not necessarily parallel to a central axis of the solid propellant grain, e.g., a combustion port can be a helical port that revolves about a central axis along the length of the solid propellant grain.

The solid propellant grain 100 includes additively manufactured concentric beads 104 of solid propellant material. Each concentric bead 104 has a generally ring-shaped, circular structure, with a substantially circular length of material and a substantially circular opening defined within the circular length of material. The radius of a concentric bead is the radius of the cylinder at the position of that bead. A given bead 104 is fused at its outer edge (e.g., in the direction of the radius of the solid propellant grain 100) to a concentric bead of a larger radius and at its inner edge to a concentric bead of a smaller radius. Each concentric bead 104 is also fused along the axis of the solid propellant grain 100 to other concentric beads of substantially the same radius, thereby forming radially oriented layers of beads. Concentric beads that are fused along the axial direction are not concentric with one another, but are concentric with other concentric beads in the radial direction. The multiple concentric beads of substantially the same radius that are fused together along the axial direction of the solid propellant grain 100 constitute an axially oriented layer 106 of the solid propellant grain. The concentric beads 104 are thus arranged into concentric, substantially cylindrical layers 106 with substantially circular cross section, with an outermost layer 106b forming an outer wall of the solid propellant grain 100 and an innermost layer 106a defining the wall of the combustion port 102.

FIG. 1B illustrates an example process for additive manufacturing of a solid propellant grain such as that of FIG. 1A. In this process, a stable solid propellant material, e.g., a thermoplastic solid propellant material, is extruded through a nozzle of an additive manufacturing system and deposited as concentric beads 104. For instance, to fabricate a cylindrical solid propellant grain 100 having a combustion port 102 with a circular cross section, as illustrated, the deposited beads 104 are circular beads. The innermost concentric bead 104a will form part of the innermost layer 106a of the solid propellant grain and the outermost concentric bead 104b will form part of the outermost layer 106b of the solid propellant grain. Other shapes of beads are also possible, e.g., depending on the desired shape of the solid propellant grain and/or the configuration of the additive manufacturing tool (e.g., the geometry of the extruder nozzle).

As illustrated, the solid propellant grain 100 is fabricated in a vertical orientation, e.g., in which a first-deposited set 156 of concentric beads with increasing radius is deposited onto a substrate 158 such that the beads fuse with one another, and subsequent sets of concentric beads are deposited onto the previous sets such that the sets of beads fuse with one another, and such that the solid propellant grain 100 and combustion port 102 extend perpendicularly away from the substrate 158. In some examples, solid propellant grains can be fabricated in a horizontal orientation, e.g., using a mandrel, such as using processes similar to those for additive manufacturing of hybrid fuel grains as described in U.S. Ser. No. 17/544,236, the contents of which are incorporated herein by reference in their entirety.

Also as illustrated, the solid propellant grain 100 is fabricated using an extruder tool path that forms concentric beads. Other tool paths can also be used for additive manufacturing of solid propellant grains. For instance, solid propellant grains can be formed of elongated, axially-aligned beads or beads of other orientations or configurations.

A solid propellant material generally refers to a solid, combustible material that is composed of a mixture of fuel and oxidizer constituents provided in relative amounts such that the mixture is capable of sustaining combustion, e.g., for a solid rocket motor. Solid propellant materials include a solid oxidizer and a solid fuel material. In some examples, the solid propellant materials include a solid fuel additive and a separate binder material. In some examples, the solid propellant materials include a binder material that serves as a primary fuel material such that the solid propellant material does not include a solid fuel additive. In some examples, the solid propellant materials include a solid oxidizer, a solid fuel additive, and a binder material that serves as a supplemental lower energy density fuel. In some examples, the solid propellant material also includes additional additives.

The oxidizers for solid propellant materials used in the solid propellant grains and hybrid fuel grain assemblies (discussed below) described here can be solid oxidizers that are commonly used in conventional solid propellant formulations, e.g., potassium nitrate, potassium perchlorate, ammonium nitrate, ammonium perchlorate, sodium perchlorate, or other suitable oxidizers. When additive manufacturing is used to form the solid propellant material (discussed further below), the oxidizers are materials that are compatible with additive manufacturing processes, e.g., oxidizers that are thermally stable at the temperatures used during additive manufacturing processes, resistant to shear/friction, or stable against other stimuli likely to be present during additive manufacturing.

The composition of the fuel material and/or the binder material can depend on the process used to fabricate the solid propellant grain or hybrid fuel grain assembly. When the solid propellant material is deposited by additive manufacturing, such as fused deposition modeling additive manufacturing, various types of thermoplastic polymers that are typically used in additive manufacturing processes can be used as the binder material, such as ABS (acrylonitrile butadiene styrene, PLA (polylactic acid), PMMA (polymethyl methacrylate), or other suitable thermoplastics. In some examples, the binder material can be a lower melting point thermoplastic, such as PCL (polycaprolactone), EVA (ethylene vinyl acetate), thermoplastic elastomers (TPE) such as thermoplastic polyurethane (TPU), or other suitable low melting point thermoplastics. Use of a lower melting point thermoplastic can improve safety by providing a larger margin between processing temperature and ignition temperature of the propellant formulation of the solid fuel material. In some examples, other lower melting point materials can be used as the binder material, such as sugar based materials such as sorbitol, sucrose, or dextrose. In some examples, the binder material can be an ultraviolet light curable resin. Other types of binder materials can be used in conjunction with different types of additive manufacturing. For instance, binder materials can be used that are compatible with solvent-based methods in which a binder material that is softened or dissolved in a solvent is allowed to flow through a nozzle and solidified through solvent evaporation. In addition, extruders can be designed for additive manufacturing of binder materials such as hydroxyl-terminated polybutadiene (HTPB) based thermoset formulations.

The solid fuel additive can be a solid fuel material that is commonly used in conventional solid propellant formulations, e.g., metallic fuel additives such as aluminum powder. Other additives can also be used, e.g., burn rate modifiers, processing aids, or other suitable additives. The additives can be materials that have decomposition temperatures above a processing or forming temperature of the solid propellant material, and that, when added, do not result in the propellant ignition temperature falling below the forming temperature of the solid propellant material. For instance, this decomposition temperature criterion for the additive can be relevant when additive manufacturing is used to form the solid propellant material.

In some examples the binder material serves as the fuel material, e.g., in place of a solid fuel additive. For instance, a binder material such as HTPB or a thermoset polymer such as PBAN or CTPB can be mixed with a suitable oxidizer, such as ammonium perchlorate, resulting in a mixture that can sustain combustion without the use of a solid fuel additive.

Example solid propellant materials have compositions, e.g., containing 15-25% by weight thermoplastic polymer binder, 10-20% solid fuel additive such as aluminum, and 65-75% solid oxidizer. In a specific example, a solid propellant material suitable for deposition by additive manufacturing contains 20% thermoplastic polyurethane binder (e.g., Pearlstick™ 5703, Lubrizol, Brecksville, OH), 15% H2 aluminum solid fuel additive having an average particle size of about 3.5 microns, and 65% potassium perchlorate solid oxidizer.

Additive manufacturing of solid propellant material can be performed using shelf-stable solid propellant material formulations. This enables solid propellant grains or hybrid fuel grain assemblies to be manufactured on-demand, e.g., on location.

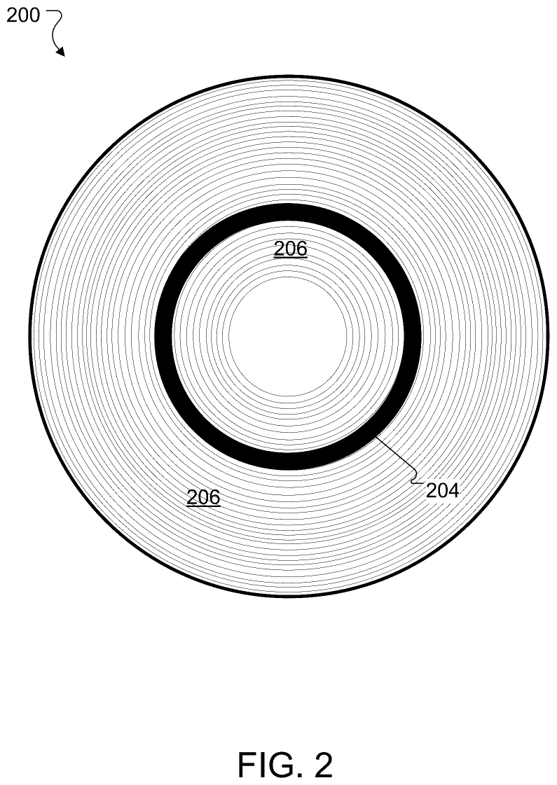

Additive manufacturing of solid propellant grains allows for flexibility in the composition of the solid propellant grain. For instance, the formulation of the solid propellant material can vary radially (e.g., from the innermost layer of concentric beads defining the wall of the combustion port to the outermost layer of concentric beads defining the exterior surface of the solid propellant grain) or axially (e.g., along the length of the solid propellant grain). Alternatively or additionally, local, discontinuous variations in composition can be implemented. For instance, small, discontinuous sections of one solid propellant formulation can be embedded within another formulation that forms the bulk of the solid propellant grain. An example of such a structure is shown in FIG. 2, in which a solid propellant grain 200 includes an interior section including one or more layers of a first formulation solid propellant material 204 disposed between and in contact with layers of a second, different formulation of solid propellant material 206. In the example of FIG. 2, the layer of solid propellant material 204 is a circumferentially continuous layer. However, additive manufacturing of solid propellant material provides flexibility in the configuration of the interior solid propellant material. For instance, the interior solid propellant material can extend around only a portion of the circumference, and/or can extend along all or only a portion of the length of the solid propellant grain.

Solid propellant grains with internal composition variations can be relevant for providing desired energy (e.g., thrust) profiles. In an example, interior solid propellant material formulations can be incorporated into a solid propellant grain to form a wired endburner structure, in which one formulation of solid propellant material is embedded within a different formulation of solid propellant material to enhance heat transfer into the solid propellant grain by tailoring the thermal transport properties of the various formulations. For instance, the embedded formulation can be a reactive energic that burns more rapidly than the surrounding formulation and causes ignition of the surrounding material once initiated, thereby allowing new combustion ports to open up within the solid propellant grain. Such approaches can improve the overall propellant load within a given solid rocket motor without sacrificing volume. Other configurations of interior solid propellant material can provide other functional advantages. For instance, in conventional solid rocket motors, a wired endburner uses thermally conductive materials, such as metal wires (e.g., copper) to propagate heat into the propellant volume to improve burning rates. Interior solid propellant material having higher thermal conductivity than the surrounding material can be configured to have similar functionality, while advantageously providing consumable material rather than wires occupying the endburner space.

The process parameters of the additive manufacturing system are set such that the solid propellant material is flowable but does not ignite. For instance, the processing temperature at which the solid propellant material is printed, extruded, or otherwise deposited is set to provide a safe margin between the processing temperature and the ignition temperature of the components of the solid propellant material, and also to provide a safe margin between the processing temperature and the decomposition temperature of the components of the solid propellant material. Additionally, when solid propellant material is deposited in conjunction with hybrid fuel grain material (discussed below) to form hybrid rocket engine fuel grain assemblies, the processing temperature for the deposition of the fuel grain material is also set to provide a sufficient margin of safety. In some examples, the composition of the binder material, oxidizer, and any additives is selected to enable this temperature differential to be achieved.

Process parameters for additive manufacturing of the solid propellant material can be tuned to control behavior of the solid propellant material during and/or after printing. For instance, processing aids such as additives can be introduced into the solid propellant material to tune the melt viscosity, solidification time, or other characteristics of the solid propellant. As an example, a base thermoplastic material with a given melting point can be blended with another melt-processable material such as a different thermoplastic with a lower melting point. This mixture will have a lower viscosity at lower temperature than the base thermoplastic alone, which can enable the processing temperature to be reduced. For instance, ethylene-vinyl acetate (EVA), which is a copolymer of ethylene and vinyl acetate, can be added to a base thermoplastic, and the melting temperature of the mixture can be tuned based on the relative quantities of the ethylene and the vinyl acetate in the copolymer. Other examples of processing aids can include processing aids used with conventional solid propellant formulations, e.g., plasticizers, provided the processing aid is compatible with the conditions of additive manufacturing.

In some examples, additive manufacturing of solid propellant material is achieved using a twin-screw extruder system with multiple feeders. The components of the solid propellant material (e.g., oxidizer, binder, and any additives) are fed into the extruder system in metered quantities, and the shearing action of the internal screw elements mixes the components. In some implementations, this approach can avoid heating or melting of the binder material, thus mitigating ignition hazards. For instance, when the thermoplastic material of the solid propellant is premixed, softened, or dissolved in a suitable solvent, the extruder system can be operated at relatively low temperatures, e.g., at ambient temperature, reducing risk of accidental ignition. Solvent can subsequently be removed via vacuum sections and recovered and/or recycled, reducing waste generation. In some examples, with suitable extruder design (e.g., a twin-screw extruder system under suitable processing conditions), heat and/or shear from the extruder can melt the polymer and mix the propellant constituents, thereby avoiding the use of solvents.

Twin-screw extruder systems can be used for fabrication of additive manufacturing feedstock which is then deposited in a separate additive manufacturing system. In some examples, twin-screw extruder systems can be used for additive manufacturing itself. For instance, a single extruder system can be configured to mix the raw constituents into a homogeneous mixture and to print that mixture.

In some examples, additive manufacturing of both solid propellant material and hybrid fuel grain material is used to fabricate a hybrid fuel grain assembly for a hybrid rocket engine. A hybrid fuel grain assembly is a hybrid fuel grain formed of fuel grain material, and further including a small amount of solid propellant material, e.g., disposed on an inner surface of the hybrid fuel grain.

A fuel grain material generally refers to a solid, combustible fuel material for use in a hybrid rocket engine. Generally, a fuel grain material is a material that does not sustain combustion on its own, but is combustible in the presence of a separate oxidizer to thereby allow the fuel grain material and oxidizer to serve as a propellant. Example fuel grain materials include a polymer based rocket fuel material, e.g., such as acrylonitrile butadiene styrene (ABS) thermoplastic or another polymer based rocket fuel material having desired combustion properties. Example fuel grain materials can also include micron-scale or nanoscale additives, such as micron-scale or nanoscale metal particles (e.g., aluminum or magnesium particles), micron-scale or nanoscale metal hydride particles, micron-scale or nanoscale polymer particles, or other suitable additives. In some examples, the micron-scale or nanoscale metallic particles are passivated with a polymer coating. In some examples, the micron-scale or nanoscale metallic particles have an oxide shell (e.g., aluminum particles can have an aluminum oxide shell). The additive particles can be of any suitable geometry, e.g., spheres, flakes, ellipses, or other geometries. In some examples, fuel grain materials do not contain an oxidizer. In some examples, the fuel grain material contains an additive that is an oxidizer, e.g., in small enough quantities that the oxidizer content in the fuel grain material is insufficient to sustain combustion that produces thrust.

When the fuel grain material includes micron-scale additives (e.g., micron-scale metallic, metal hydride, or polymer particles, or particles of another composition), the micron-scale particles have an average dimension (e.g., diameter) of between 1 μm and 1000 μm, e.g., between 1 μm and 500 μm or between 1 μm and 100 μm, e.g., 1 μm, 10 μm, 25 μm, 50 μm, 100 μm, 250 μm, 500 μm, or 1000 μm. When the fuel grain material includes nanoscale additives (e.g., nanoscale metallic, metal hydride, or polymer particles, or particles of another composition), the nanoscale particles have an average dimension (e.g., diameter) of less than 1 μm, e.g., 500 nm or less, or 100 nm or less, e.g., 500 nm, 400nm, 300 nm, 200 nm, 100 nm, 50 nm, 20 nm, 10 nm or another diameter. Generally, the fuel grain material is composed of between about 75% and 95% by weight of the hybrid rocket fuel material and between about 5% and 25% by weight of the micron-scale or nanoscale additive. In some examples, higher concentrations of additives can be present in the fuel grain material.

The small amount of solid propellant material in a hybrid fuel grain assembly aids with ignition of the fuel grain material, which advantageously enables hybrid rocket engines to perform comparably to solid rocket motors during initial startup transients. For instance, the fast action of the solid propellant material rapidly provides heat to the hybrid fuel grain material and enables a rapid increase in engine pressure, which shortens the transient startup period of the hybrid rocket engine. In some examples, the solid propellant material in an otherwise hybrid rocket engine can produce sufficient thrust to initially accelerate a vehicle or other movable device while the system transitions into hybrid operation.

Additive manufacturing of hybrid fuel grain assemblies including both hybrid fuel grain material and solid propellant material allows for flexibility in terms of the compositional profile of the fuel grain assemblies. For instance, manufacturing hybrid fuel grain assemblies using additive manufacturing can enable fabrication of customized arrangements of materials, e.g., fabrication of hybrid fuel grain assemblies having solid propellant material interspersed with hybrid fuel grain material, hybrid fuel grain assemblies having different solid propellant material formulations in different locations, or hybrid fuel grain assemblies having controllable surface morphologies. These customized materials arrangements in turn enable target energy (e.g., thrust) profiles to be achieved.

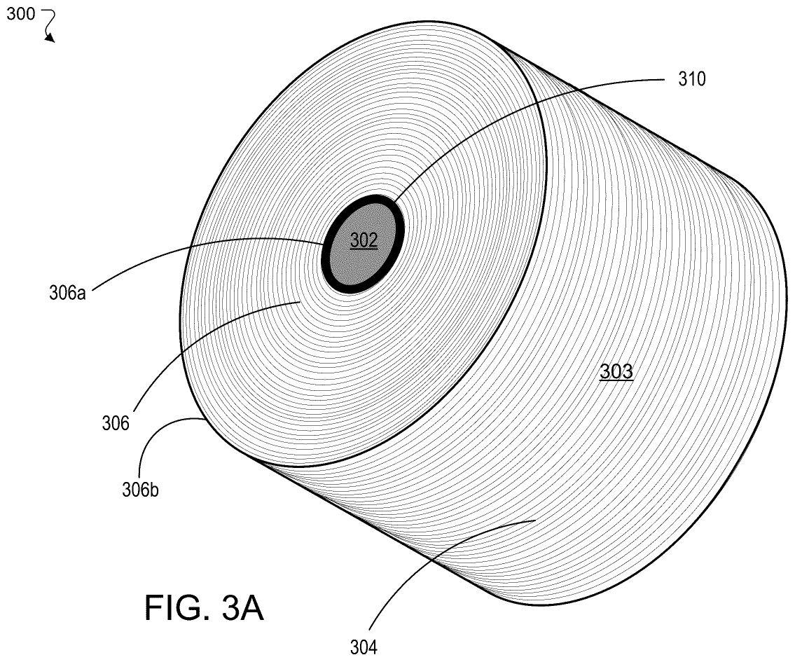

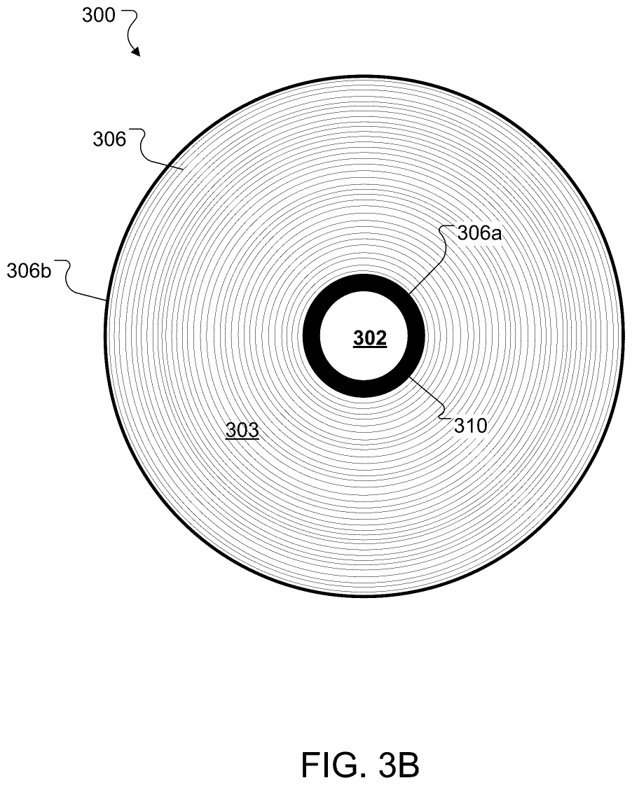

Referring to FIGS. 3A-3B, in an example, additive manufacturing is used to fabricate a hybrid fuel grain assembly 300 for a hybrid rocket engine, shown in perspective (FIG. 3A) and cross-sectional (FIG. 3B) views. The hybrid fuel grain assembly 300 as illustrated has a generally cylindrical shape, e.g., an elongated tubular shape with a substantially circular cross section. A hollow combustion port 302 is defined in the interior of the hybrid fuel grain assembly 300, e.g., centered within the fuel grain assembly, and extends axially along the length of the hybrid fuel grain assembly 300. The combustion port 302 has a substantially circular cross section. Although the hybrid fuel grain assembly 300 is illustrated as being cylindrical and with a substantially cylindrical combustion port, other shapes of hybrid fuel grain assemblies and combustion ports are also within the scope of this disclosure. For instance, hybrid fuel grain assemblies can be elongated, non-cylindrical structures, disc-shaped structures, or other suitable shapes. Additionally, hybrid fuel grain assemblies can have various shapes of combustion ports, and can have one or multiple combustion ports. For instance, the combustion ports are not necessarily parallel to a central axis of the hybrid fuel grain assembly, e.g., a combustion port can be a helical port that revolves about a central axis along the length of the hybrid fuel grain assembly.

The hybrid fuel grain assembly 300 includes a hybrid fuel grain 303 formed from additively manufactured concentric beads 304 of hybrid fuel grain material. Each concentric bead 304 has a generally ring-shaped, circular structure, with a substantially circular length of material and a substantially circular opening defined within the circular length of material. The radius of a concentric bead of a cylindrical fuel grain is the radius of the cylinder at the position of that bead. A given bead 304 is fused at its outer edge (e.g., in the direction of the radius of the fuel grain assembly 300) to a concentric bead of a larger radius and at its inner edge to a concentric bead of a smaller radius. Each concentric bead 304 is also fused along the axis of the fuel grain 303 to other concentric beads of substantially the same radius. Concentric beads that are fused along the axial direction are not concentric with one another, but are concentric with other concentric beads in the radial direction. The multiple concentric beads of substantially the same radius that are fused together along the axial direction of the fuel grain 303 constitute a layer 306 of the fuel grain. The concentric beads 304 are thus arranged into concentric, substantially cylindrical layers 306 with substantially circular cross section, with an outermost layer 306b forming an outer wall of the fuel grain 303.

The hybrid fuel grain assembly 300 also includes a solid propellant material 310 disposed by additive manufacturing on an innermost layer 306a of the fuel grain 303, such that the solid propellant material forms at least a portion of a wall of the combustion port 302. In some examples, the solid propellant material 310 is a continuous layer that forms the entirety of the wall of the combustion port 302. In some examples, the solid propellant material 310 is a layer of uniform thickness along the entire wall of the combustion port 302; in some examples, the thickness of the solid propellant material varies. In some examples, the solid propellant material 310 is disposed on only a portion of the innermost layer 306a of the fuel grain material such that the solid propellant material 310 and the uncovered portions of the innermost layer 306a of the fuel grain 303 together form the wall of the combustion port 302.

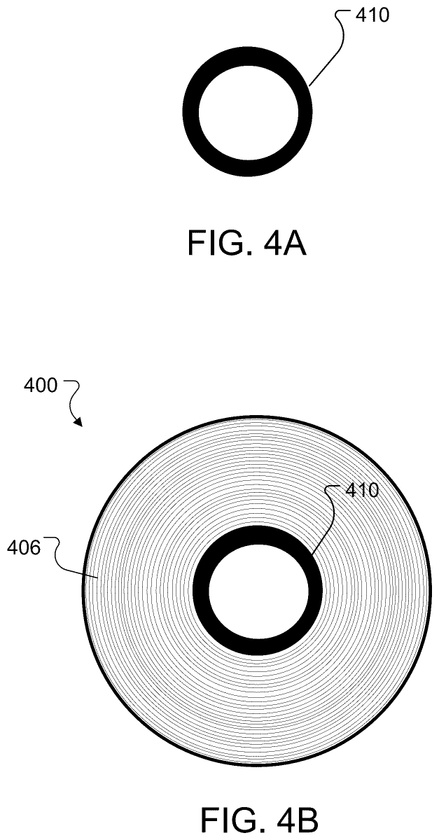

In some examples, the hybrid fuel grain assembly 300 is fabricated using additive manufacturing in a vertical orientation, e.g., as described above for FIG. 1. For instance, FIG. 4A illustrates a top view of a first set 356 of concentric beads with increasing radius deposited onto a substrate 358 as part of a process of fabricating the fuel grain assembly 300. The first set of concentric beads includes inner beads 360 of solid propellant material bounding an area 352 that will form part of the combustion port and outer, larger-radius beads 362 of fuel grain material. Adjacent beads are fused together. As with the process of FIG. 1, subsequent sets of concentric beads are deposited onto the previous sets such that the sets of beads fuse with one another as shown in FIG. 4B, and such that the resulting fuel grain assembly 300 extends perpendicularly away from the substrate 358.

In some examples, the hybrid fuel grain assembly can be fabricated in a horizontal orientation by depositing concentric beads of solid propellant material onto a mandrel, and depositing subsequent layers of concentric beads of material such that the resulting fuel grain assembly extends radially around the mandrel.

Additive manufacturing fabrication of hybrid fuel grain assemblies allows for the fabrication of hybrid fuel grain assemblies having solid propellant material having a non-uniform thickness along the length of the hybrid fuel grain assembly or having solid propellant material that does not extend along the entire length of the hybrid fuel grain assembly. To fabricate such fuel grain assemblies, beads of solid propellant material having different sizes, and/or different numbers of layers of solid propellant material are disposed at different locations. In some examples, the thickness of the solid propellant material can be varied by alternating deposition of solid propellant beads with solid fuel grain material beads, e.g., with a progressive variation in the relative number of each kind of beads to achieve a progressively thinner or thicker layer of solid propellant material.

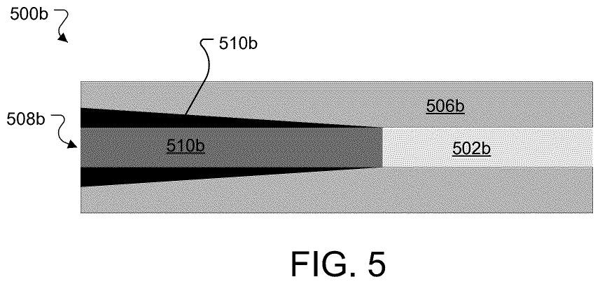

FIG. 5 is a cross-sectional view of an example hybrid fuel grain 500 having solid propellant material 510 with a non-uniform thickness along the length of the fuel grain assembly 500 and extending along less than an entire length of the fuel grain assembly 500. The fuel grain 500 also includes layers 506 of beads of fuel grain material and a combustion port 502. The solid propellant material 510 is deposited by additive manufacturing such that it extends along a portion of the length of the combustion port 510 with a monotonically decreasing thickness from a maximum thickness at an inlet end 508 of the combustion port 510.

Other variations in solid propellant material placement can also be implemented via additive manufacturing deposition of the solid propellant material. For instance, the solid propellant material can be deposited in discontinuous regions. The solid propellant material can be deposited in patterns such as stripes or checkerboard patterns, e.g., with the pattern being an alternation between solid propellant material of different morphology or between regions where solid propellant material is disposed and regions where no solid propellant material is disposed. Variations in solid propellant material placement can provide more exposed surface area for combustion to occur, e.g., akin to more elaborate port geometries in conventional cast solid rocket motors. Uneven/varying placement of solid propellant material also can allow for tailoring of the engine performance during the initial phase. For instance, the solid propellant material can be printed in a configuration to produce a port geometry different from that of the underlying fuel grain material. In an example, a fuel grain may have a cylindrical combustion port with a circular cross section, and may include solid propellant material arranged to define a combustion port with a different geometry (e.g., star, dog bone, wagon wheel, slotted cylinder, or other suitable geometry) to thereby produce a desired effect (e.g., thrust profile).

In some examples, additive manufacturing process parameters, such as nozzle size, number of extruders, and/or print layer height, can be varied to achieve a target surface roughness for the layer(s) of solid propellant material. In some examples, the morphology, e.g., surface roughness, of the solid propellant material is tailored to achieve a target performance. For example, a solid propellant with a higher surface area (e.g., a high surface roughness) can be used to improve ignitability and/or to increase the amount of burning surface, e.g., as compared to a smoother solid propellant. Moreover, a solid propellant with high surface area can produce a high amount of thrust for a short period of time. The morphology of the solid propellant layer can be uniform along the entire combustion port or can vary with location.

Configurations in which the surface morphology of the solid propellant material varies with location along the combustion port can be relevant for applications in which the solid propellant material is used to produce initial thrust (e.g., as opposed to being used to preheat the fuel grain material). A particular thrust profile can be achieved by tailoring the surface morphology of the regions of solid propellant material.

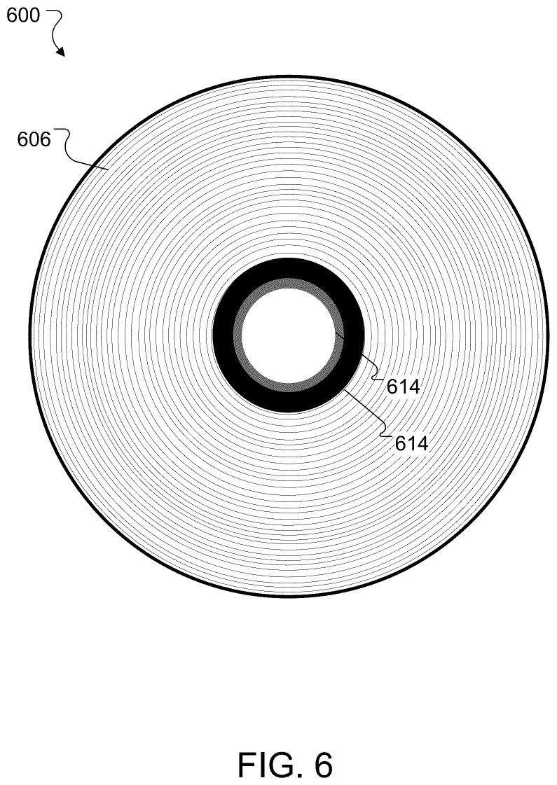

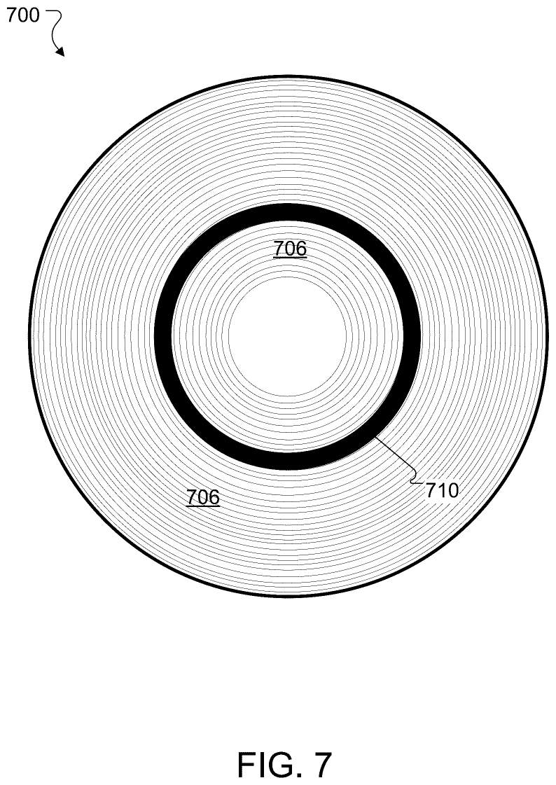

Additive manufacturing fabrication of hybrid fuel grain assemblies allows for the fabrication of fuel grain assemblies having multiple layers of solid propellant material of different formulations. In some examples, to form a solid propellant material structure having multiple layers, multiple rounds of deposition are performed using different materials as appropriate to form the solid propellant material structure. For instance, referring to FIG. 6, beads of highly energetic solid propellant material are disposed by additive manufacturing to define an innermost layer 614 of a hybrid fuel grain assembly 600, beads of less energetic solid propellant material are deposited by additive manufacturing adjacent to the innermost layer 614 to define an outer layer 612 of solid propellant material, and beads of hybrid fuel grain material are deposited adjacent to the outer layer 612 to form layers 606 of fuel grain material. The performance of the fuel grain assembly, e.g., ignition and/or thrust performance, can be tailored based on the different compositions of solid propellant material in the outer and inner layers 612, 614. For instance, the inner layer 614 can include solid propellant material and an energetic additive with higher reactivity or increased sensitivity so as to promote rapid ignition of the less energetic, slower burning composition of the inner layer 614.

Additive manufacturing fabrication of hybrid fuel grain assemblies allows for the fabrication of fuel grain assemblies having interior solid propellant material disposed amidst the hybrid fuel grain material. The solid propellant material can be positioned at desired locations by controlling operation of the additive manufacturing tool, e.g., by depositing beads of solid propellant material at certain locations during fabrication. FIG. 7 shows an example hybrid fuel grain assembly 700 that includes a layer of solid propellant material 710 disposed between and in contact with two layers 706 of fuel grain material. In the example of FIG. 7, the layer of solid propellant material 710 is a circumferentially continuous layer. However, additive manufacturing of solid propellant material provides flexibility in the configuration of the interior solid propellant material. For instance, the interior solid propellant material can extend around only a portion of the circumference, and/or can extend along all or only a portion of the length of the fuel grain assembly. The configuration of the interior solid propellant can allow for the hybrid engine to rapidly transition from one fuel grain geometry to another during certain phases of the burn. For instance, a cylindrical section of interior solid propellant material can enable a rapid switch to a larger port diameter. More complex interior solid propellant geometries can be designed such that when the interior solid propellant is consumed, the geometry of the combustion port for the remaining fuel material is different from the initial port geometry. For instance, the new combustion port can have a higher surface area or a non-circular cross section. These approaches can be relevant for hybrid rocket engines with fixed oxidizer mass flow rate, e.g., in their ability to help counteract the decrease in regression rate that occurs as port diameter increases.

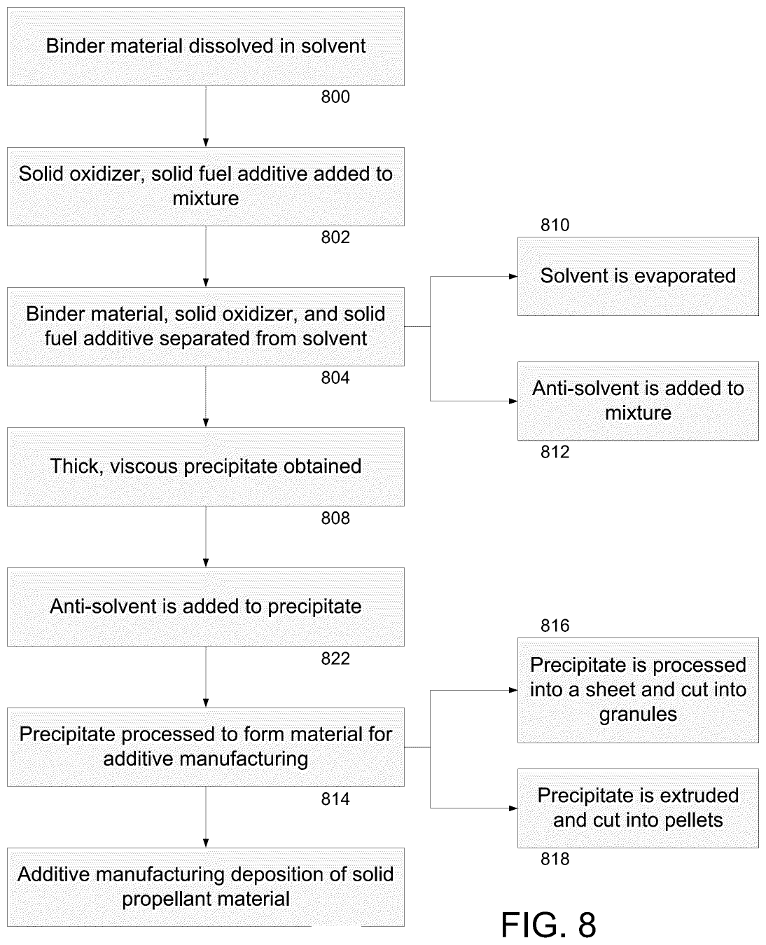

Also described here are processes for preparing solid propellant material in a form, e.g., pellets or filaments, compatible with additive manufacturing. Referring to FIG. 8, in an example process, the binder material is first dissolved in a solvent (800), such as acetone, ethyl acetate, methyl ethyl ketone, etc., or other suitable solvents. The solvent depends on the type of thermoplastic; for instance, acetone may be used as a solvent for ABS, while methyl ethyl ketone may be used as a solvent for various TPU materials. Generally, a solvent is used in which the thermoplastic has high solubility. In some examples, excess solvent can be used, e.g., to reduce the viscosity of the mixture., followed by addition of other components of the solid propellant material (e.g., solid oxidizer, solid fuel additive, and any other additives) to produce a homogeneous mixture (802). The solvent can be selected for its capability to dissolve the binder material, its viscosity, and its compatibility with other components of the solid propellant material. The homogenous mixture can be processed in a variety of ways, beginning with separation of the binder material, solid oxidizer, and solid fuel additive from the solvent (804) to obtain a thick, viscous precipitate (808). In one example, the mixture is continuously mixed while the solvent evaporates (810), e.g., with addition of heat and/or vacuum to promote evaporation. Over time, as the solvent evaporates, the mixture will increase in viscosity and ultimately leaving a thick, viscous precipitate. In one example, an appropriate volume of a suitable anti-solvent (e.g., a solvent that is completely miscible with the initial solvent but unable to dissolve the binder) is added to the mixture (812), causing the binder polymer to precipitate out of solution onto the solid components of the solid propellant material, rapidly forming a large solid agglomeration. The composition of the anti-solvent depends on the nature of the binder material and the solvent. Generally, the anti-solvent is non-reactive with, and substantially does not dissolve, the solid material in the mixture. In a specific example, isopropyl alcohol is used as an anti-solvent given its low cost, miscibility with commonly used solvents, and limited solubility for the solids of interest. Generally, both the solvent and the anti-solvent are sufficiently volatile that they can be removed via convective air and/or vacuum drying processes.

The resulting thick, viscous material is processed to form appropriately sized and shaped material for use in additive manufacturing (814), e.g., granules for use in a pellet-based 3D printer or filaments for use in fused filament deposition. In one example, the thick, viscous material is processed into a sheet and then cut into pellets or granules (816). In one example, the thick, viscous material, still in a semi-pliable state, is extruded under pressure through a die to produce a material with uniform cross-section, which can be extruded, e.g., through a heated single or twin screw extruder and used as filament, or cut after being extruded to produce pellets (818). The extrudate or pellets are used for additive manufacturing deposition of solid propellant material (820).

In some examples, thick, viscous material is wet, and processing can help avoid agglomeration of the mixture due to residual solvent. For instance, in cases where the thick, viscous material is wet, the outermost surfaces may dry such that they can be handled without sticking, but the interior of the material may still be wet and sticky and thus difficult to handle. Thus, if such wet material is cut into pieces, the exposed surfaces of those pieces may be wet and likely to stick back together if not sufficiently separated. Similarly, a solvent wet mass processed by pelletization through an extrusion based method with a cutter can also produce pellets or granules that stick together.

To mitigate this agglomeration, in some examples, an anti-solvent can be introduced during the extrusion or pelletization process (822). The presence of the anti-solvent solidifies the outermost surfaces of the extruded or pelletized material, thereby mitigating the agglomeration of the mixture.

In some examples, additive manufacturing can be used for fabrication of other pyrotechnics or polymer-bonded explosives. For instance, explosive charges have a small quantity of a highly sensitive explosive as an initiator or detonator, which upon detonation imparts a detonation wave that initiates detonation of a larger quantity of a less sensitive booster explosive, and subsequently detonation of the bulk charge. The fabrication of the initiator or detonator explosive can be implemented as described above for the solid propellant material, e.g., using additive manufacturing under conditions that avoid detonation of the explosive material being printed.

Particular embodiments of the subject matter have been described. Other embodiments are within the scope of the following claims.

What is claimed is:

1. A method comprising:
depositing beads of solid propellant material using additive manufacturing to form a fuel element for a rocket engine, the fuel element comprising beads of solid propellant material, wherein a combustion port extends through the fuel element,
wherein the solid propellant material comprises an oxidizer and a binder material.

2. The method of claim 1, wherein the fuel element comprises a solid propellant grain for a solid rocket motor.

3. The method of claim 1, wherein the fuel element comprises a fuel grain assembly for a hybrid rocket engine.

4. The method of claim 1, wherein depositing beads of solid propellant material comprises extruding the solid propellant material from a nozzle of an additive manufacturing system.

5. The method of claim 1, comprising depositing beads of solid propellant material to form at least one layer composed of solid propellant material.

6. The method of claim 5, comprising depositing multiple concentric beads of solid propellant material such that the fuel element comprises multiple layers of beads.

7. The method of claim 1, comprising depositing beads of solid propellant material such that innermost beads of the solid propellant material define a wall of the combustion port and outermost beads of the solid propellant material define an outer surface of the fuel element.

8. The method of claim 1, comprising depositing beads of solid propellant material of different compositions such that a composition of the fuel element varies radially, circumferentially, or axially.

9. The method of claim 1, comprising depositing the beads of solid propellant material at a temperature that is lower than an ignition temperature of the solid propellant material.

10. The method of claim 1, wherein the solid propellant material comprises a solid fuel additive.

11. The method of claim 1, comprising depositing beads of fuel grain material in contact with the beads of solid propellant material to form a fuel grain assembly for a hybrid rocket engine, the fuel grain assembly comprising one or more layers of fuel grain material, wherein the fuel grain material comprises a polymer based rocket fuel material.

12. The method of claim 11, comprising depositing beads of the solid propellant material and the fuel grain material such that beads of the solid propellant material define a wall of the combustion port and beads of the hybrid fuel grain material define an outer surface of the hybrid fuel grain assembly.

13. The method of claim 11, comprising depositing beads of the solid propellant material and the fuel grain material such that beads of the solid propellant material and beads of the hybrid fuel grain material together define a wall of the combustion port.

14. The method of claim 11, comprising depositing beads of the solid propellant material and the fuel grain material such that solid propellant material is disposed between layers of the hybrid fuel grain material.

15. The method of claim 11, comprising depositing beads of the solid propellant material such that a thickness of the solid propellant material varies along a length of the hybrid fuel grain assembly.

16. A method comprising:
dissolving a binder material for a solid propellant material in a first solvent to produce a mixture;
introducing a solid oxidizer into the mixture;
separating the binder material and solid oxidizer from the first solvent to form a precipitate composed of solid propellant material; and
processing the precipitate to form filaments or pellets of the solid propellant material, wherein the filaments or pellets are configured for additive manufacturing of the solid propellant material.

17. The method of claim 16, comprising introducing a solid fuel additive into the mixture and separating the binder mixture, solid oxidizer, and solid fuel additive from the first solvent to form the precipitate.

18. The method of claim 16, wherein separating the binder material and solid oxidizer from the first solvent comprises evaporating the first solvent.

19. The method of claim 16, wherein separating the binder material and solid oxidizer from the solvent comprises adding a second solvent to the mixture to induce precipitation of the binder material and solid oxidizer from the first solvent.

20. The method of claim 19, wherein the second solvent is miscible with the first solvent, and wherein the binder material and solid oxidizer are insoluble in the second solvent.

21. The method of claim 16, wherein processing the solid precipitate to form pellets comprises forming a sheet of the precipitate.

22. The method of claim 16, wherein processing the solid precipitate to form filaments or pellets comprises extruding the precipitate through a die to produce an extrudate.

23. The method of claim 16, wherein processing the solid precipitate to form filament or pellets comprises extruding the precipitate through a screw extruder.

24. The method of claim 16, comprising combining a second solvent with the precipitate during the processing.

25. The method of claim 24, wherein the binder material and solid oxidizer are insoluble in the second solvent.

26. The method of claim 24, wherein in the presence of the second solvent, an external surface of an extrudate or filament or pellet produced during the processing is solidified.

27. The method of claim 16, comprising providing the filaments or pellets to an additive manufacturing tool for deposition of the solid propellant material.
